(19) United States
(12) Patent Application Publication
(10) Pub. No.: US 2010/0250354 A1
(43) Pub. Date: Sep. 30, 2010

(54) SYSTEMS, DEVICES AND METHODS FOR INCENTIVE-BASED TRANSACTIONS

(75) Inventor: Olivier Waucampt, Rio de Janeiro (BR)

Correspondence Address: MINTZ, LEVIN, COHN, FERRIS, GLOVSKY AND POPEO, P.C, ONE FINANCIAL CENTER, BOSTON, MA, 02111, US

(73) Assignee: ACCOR SERVICES NORTH AMERICA, INC., Watertown, MA (US)

(21) Appl. No.: 12/725,317

(22) Filed: Mar. 16, 2010

Related U.S. Application Data
(60) Provisional application No. 61/160,658, filed on Mar. 16, 2009.

(51) Int. Cl. G06Q 30/00; G06Q 40/00

(52) U.S. Cl. 705/14.17; 235/379

(57) ABSTRACT

Disclosed are systems, methods and devices, including a method that includes processing a card configured to maintain data identifying one or more of a user and at least one organization, the card also configured to enable access to a plurality of accounts of stored values, each account associated with retailers at which the user may apply the value of the corresponding account to make purchases at the respective one or more associated retailers. The method also includes, in response to making a purchase at a first retailer, determining a cash-back amount based on, for example, the identity of the user and the at least one organization, and adding the determined cash-back amount to an account from the plurality of accounts determined to be associated with the first retailer, the total in the account being available to pay for subsequent purchases at retailers associated with the account.

### CROSS-REFERENCE TO RELATED APPLICATION

This application claims priority to provisional U.S. application Ser. No. 61/160,658, entitled “Systems and Methods for Implementing Discounted Transactions,” and filed Mar. 16, 2009, the content of which is hereby incorporated by reference in its entirety.

### BACKGROUND

The present disclosure relates to systems for implementing transactions, and more particularly to systems, devices and methods for implementing incentive-based transactions (e.g., transactions awarding the cardholder cash-back, discounts, etc.) using, for example, a user-issued card.

Employee savings programs are popular with large private and government employers. Such programs are often available for free or at a very low cost, while enhancing organizations' employee benefit package. Particularly, they improve employees' satisfaction by enabling employees to save money on the goods and services they purchase.

Merchants are ready to offer employees discounts in the range of, for example, 5% to 40% off their normal pricing to develop a new sales channel that promotes their brands in the workplace, and thus lower the cost of client acquisition and retention (other discount ranges may be used). However, current employee savings products suffer from some limitations, which imply low employee participation in such discount programs. Further, most programs only feature compelling discount offers from on-line merchants, although e-commerce represents a small fraction of total retails sales (only 3.4% in 2008 according to the US Department of Commerce). Employees therefore do not have access to discounts at brick and mortar retail outlets where they regularly shop.

Furthermore, when off-line offers are available, they are often inconvenient to redeem. For example, employees need to plan their purchase in advance and print a coupon to be submitted at the store. Given the high turnover of store cashiers, retailers' cashiers and other employees frequently do not know what to do with those printed coupons, thus spoiling the overall purchase experience. Additionally, discounts offered by existing programs are mostly limited to large ticket items that are not frequently consumed by employees, such as consumer electronics, travel & entertainment, etc.

In some embodiments, organizations (e.g., credit card companies, employers, etc.) offer cash back incentives to entice users to make purchases. Generally, cardholders may receive cash-back (e.g., either in the form of funds available for redemption with further purchases, or in the form of cashable checks) corresponding to a certain percentage (e.g., 1-2%) of their aggregate purchases over a time period (e.g., a month).

### SUMMARY

In one aspect, a method performed by execution of computer readable program code by one or more processor-based devices is disclosed. The method includes processing, by the one or more processor-based devices, a card configured to maintain data identifying one or more of a user and at least one organization, the card configured to enable access to a plurality of accounts of stored values representative of monetary amounts available for making purchases, each account being associated with one or more retailers at which the user may apply the value of the each account to make one or more purchases at the respective one or more associated retailers. The method also includes, in response to making a purchase at a first retailer, determining, by the one or more processor-based devices, a cash-back amount based on, at least in part, one or more of the identity of the user identified by the card and the at least one organization. The method further includes adding, by the one or more processor-based devices, the determined cash-back amount to an account from the plurality of accounts determined to be associated with the first retailer for the purpose of receiving cash-back, the sum of the value stored in the account and the added cash-back amount being available to pay for, at least partly, a subsequent purchase at any of the respective one or more retailers associated with the account.

Embodiments of the method include any of the following features.

The respective one or more retailers associated with the account at which the user may apply value from the account to pay for purchases may include the first retailer such that the account is configured to pay for the purchases at the first retailer and to receive cash-back when purchasing at the first retailer.

The method may further include determining a value stored in at least one account identified to be associated with the first retailer for the purpose of paying a purchase price of the purchase at the first retailer, paying for at least part of the purchase price using at least part of the stored value in the at least one account, and paying any balance of the purchase price not paid for with the stored value in the at least one account from one or more of, for example, a general account accessed through the card storing a value representative of a monetary amount available to make purchases at any retailer, available cash, a bank check, and/or any other credit/debit/prepaid card through a split tender transaction.

The method may further include updating the value stored in the at least one account to decrease the value by an amount used to pay the at least part of the purchase price using the at least part of the stored value in the at least one account.

The at least one account identified to be associated with the first retailer for the purpose of paying the purchase price may include the account determined to be associated with the retailer for the purpose of receiving cash-back when purchasing at the first retailer.

At least one retailer associated with the account to apply value in the account to pay for purchases at the at least one retailer may not be associated with another of the plurality of accounts such that another stored value on the other account is not available to pay for purchases at the at least one retailer.

The card may include a pre-paid account storing the value representative of the amount, the card being one of, for example, a pre-paid card, a credit card and/or a debit card.

The card may be configured as one or more of, for example, a debit card and a credit card, and the card may be configured to enable access to a remote server maintaining data about the plurality of accounts.

In another aspect, a computer program product residing on a computer readable medium and comprising computer instructions is disclosed. The computer instructions, when executed on one or more processor-based devices, cause the one or more processor-based devices to process a card configured to maintain data identifying a user and/or at least one organization, the card configured to enable access to a plurality of accounts of stored values representative of monetary amounts available for making purchases, each account being associated with one or more retailers at which the user may apply the value of the each account to make one or more purchases at the respective one or more associated retailers. The computer instructions further cause the one or more processor-based devices to, in response to making a purchase at a first retailer, determining a cash-back amount based on, at least in part, one or more of the identity of the user identified by the card and the at least one organization, and to add the determined cash-back amount to an account from the plurality of accounts determined to be associated with the first retailer for the purpose of receiving cash-back, the sum of the value stored in the account and the added cash-back amount being available to pay for, at least partly, a subsequent purchase at any of the respective one or more retailers associated with the account.

Embodiments of the computer program product include one or more of the above-described features of the method, as well as any of the features below.

In a further aspect, a system is disclosed. The system includes one or more processor-based devices, and a storage device coupled to the one or more processor-based devices. The storage device stores computer instructions that, when executed on the one or more processor-based devices, cause the one or more processor-based devices to process a card configured to maintain data identifying a user associated with at least one organization, the card configured to enable access to a plurality of accounts of stored values representative of monetary amounts available for making purchases, each account being associated with one or more retailers at which the user may apply the value of the each account to make one or more purchases at the respective one or more associated retailers. The computer instructions also cause the one or more processor-based devices to, in response to making a purchase at a first retailer, determine a cash-back amount based on, at least in part, one or more the identity of the user identified by the card and the at least one organization, and to add the determined cash-back amount to an account from the plurality of accounts determined to be associated with the first retailer for the purpose of receiving cash-back, the sum of the value stored in the account and the added cash-back amount being available to pay for, at least partly, a subsequent purchase at any of the respective one or more retailers associated with the account.

Embodiments of the system include one or more of the above-described features of the method and of the computer program product, as well as any of the features below.

In yet another aspect, a system is disclosed. The system includes one or more processor-based devices, and a storage device coupled to the one or more processor-based devices. The storage device stores computer instructions that when executed on the one or more processor-based devices cause the one or more processor-based devices to access, based on information obtained from a card including user identification information and information about at least one organization associated with the user, a plurality of accounts associated with a user of stored values representative of monetary amounts available for making purchases, each account being associated with one or more retailers at which the user may apply the value of the each account to make one or more purchases at the respective one or more associated retailers. The computer instructions also cause the one or more processor-based devices to receive information about a cash-back amount, determined, in response to making a purchase at a first retailer using the card, based on, at least in part, one or more of the identity of the user identified by the card and the at least one organization, and add the determined cash-back amount to an account from the plurality of accounts determined to be associated with the first retailer for the purpose of receiving cash-back, the sum of the value stored in the account and the added cash-back amount being available to pay for, at least partly, a subsequent purchase at any of the respective one or more retailers associated with the account.

Embodiments of the system include one or more of the above-described features of the method, of the computer program product, and of the first system, as well as any of the features below.

In another aspect, a device is disclosed. The device includes a card having a data-recording storage medium to record data, the data to be recorded including data identifying one or more of a user and at least one organization, the card providing access to a plurality of accounts of stored values representative of monetary amounts available for making purchases, each account being associated with one or more retailers at which the user may apply the value of the each account to make one or more purchases at the respective one or more associated retailers. The card is further configured to be processed by reading apparatus located at some of one or more retailers to provide the data identifying one or more of the user and the at least one organization, the data provided being used to, in response to making a purchase at a first retailer, make a determination of a cash-back amount based on, at least in part, one or more of the identity of the user identified by the card and the at least one organization, and to add the determined cash-back amount to an account from the plurality of accounts determined to be associated with the first retailer for the purpose of receiving cash-back, the sum of the value stored in the account and the added cash-back amount being available to pay for, at least partly, a subsequent purchase at any of the respective one or more retailers associated with the account.

Embodiments of the device include one or more of the above-described features of the method, of the computer program product, and of the systems, as well as any of the features below.

At least one of the plurality of accounts accessed by the card may further be configured to receive value through payroll deductions by an employer of the user identified by the card.

The card may include one of, for example, a credit card and debit card, the card may be pre-registered with an issuer of the card. The plurality of accounts may be accessed by another card, different from the card, such that cash-back amounts are added to one or more of the plurality of accounts in response to using the card to pay for one or more purchases at the first retailer, and values stored in the accounts are applied towards purchases in response to using the other card.

Details of one or more implementations are set forth in the accompanying drawings and in the description below. Further features, aspects, and advantages will become apparent from the description, the drawings, and the claims.

### BRIEF DESCRIPTION OF THE DRAWINGS

FIG. 1 is a schematic diagram of a system to enable use of a card to provide incentives such as cash-back benefits.

FIG. 2 is a schematic diagram of an example computing system.

FIG. 3 is a schematic diagram of an example record associated with a particular individual that includes one or more accounts to pay for purchases and/or receive cash-back values.

FIG. 4 is a flowchart of an example procedure to provide a cash-back value, or some other incentive, to a cardholder using a card.

FIG. 5 is a flowchart of an example procedure to pay the purchase price using the card.

FIG. 6 is a flowchart of an example procedure to implement discounted transactions.

### DETAILED DESCRIPTION

Described herein are apparatus, systems, methods, computer program products and devices, including a method, performed by execution of computer readable program code by one or more processor-based devices, that includes processing a card configured to maintain data identifying a user and/or at least one organization (e.g., an organization associated with the user, such as the user's employer). The card is also configured to'enable access to a plurality of accounts of stored values representative of monetary amounts available for making purchases, with each account being associated with one or more retailers at which the user (cardholder) may apply the value of the each account to make a purchase at the respective one or more associated retailers. The method also includes determining a cash-back amount, in response to making purchase at a first retailer, based on, at least in part, one or more of the identity of the user identified by the card and/or the at least one organization, and adding the determined cash-back amount to an account from the plurality of accounts determined to be associated with the first retailer for the purpose of receiving cash-back from the first retailer, the sum of the value stored in the account and the added cash-back amount being available to pay for, at least partly, a subsequent purchase at any of the respective one or more retailers at which the user may apply value from the account. In some embodiments, the respective one or more retailers associated with the account at which the user may apply value from the account to pay for purchases includes the first retailer such that the account is configured to pay for purchases at the first retailer and to receive cash-back from the first retailer. In some embodiments, the method also includes determining a value stored in at least one account identified to be associated with the first retailer for the purpose of paying a purchase price of the purchase at the first retailer, paying for at least part of the purchase price using at least part of the stored value in the at least one account, and paying any balance of the purchase price not paid for with the stored value in the at least one account from a general account accessed through the card, the general account storing a value representative of a monetary amount available to make purchases at any retailer. In some embodiments, the cards may not be personalized with the cardholder identity, but instead they could be unpersonalized and only be linked to an organization (e.g., an employer) which is the purchaser of the cards. In circumstances where it is the card issuers (be it a credit card company, an employer, or some other organization associated with the cardholder) who provide “discounts” is through cash-back (or some other incentive) after a regular transaction, the cash-back offered may be based, for example, on such factors/parameters as the date/hour of the transaction, the Merchant ID, the Merchant Category Code, location and total transaction value, etc.

Also described herein are systems, methods and devices, including a method performed by execution of computer readable program code by one or more processor-based devices. The method includes processing a card configured to maintain data identifying one or more of a user and/or at least one organization, the card configured to enable access to a stored value representative of a monetary amount available for making purchases at one or more retailers. The method also includes determining a price associated with a marketable item to be purchased at one of the one or more retailers based on at least one of the identity of the user identified by the card and/or the at least one organization, and charging the determined price using the card. Determining the price associated with the marketable item may include determining based on the at least one of the identity of the user and/or the at least one organization associated with the user whether the user is entitled to a discount on the marketable item.

In some embodiments, employers and/or other organizations provide incentive to users (e.g., employees) through discount cards. For example, an Employee Discount Card, distributed through the cardholders' employers, may be used at the point of sale of a merchant participating in a selective discount network to grant the cardholder a discount percentage based on the purchase amount, which may be credited on the card under the form of a cash-back or some other incentive. Such an incentive is ordinarily not available to consumers not in possession of such a card. While the Employee Discount Card runs on an open loop branded payment network, and therefore can be used as a payment mechanism at virtually any store where network branded cards are accepted, the cash-back discount is credited on a distinct closed loop account (or purse). That is, cash-back credits may only be available for purchases at merchants participating in the selective discount network. National merchants, who are granted exclusivity in their specific retail category, can thus be sure the discounts they provide to the Employee Discount Card participants are not spent at direct competitors, and they can therefore foster long term loyalty to their stores.

An open loop account/purse (or, in some embodiments, multiple accounts/purses) associated with a card of the Employee Discount Card, which is the account through which the employee's money is accessible for any purchase at any merchant accepting network branded cards, can be funded via several options.

One funding option is through a salary/payroll deduction scheme, where the Employee Discount Card enables employees to load funds directly out of their pay checks on a bi-weekly or monthly basis to an open loop prepaid card.

Another funding option is to set up the Employee Discount Card as a decoupled debit card, which is linked to the checking DDA account of the employee where the employer regularly does the direct deposit of his salary. All the purchase transactions done with the Employee Discount Card may be paid through automatic ACH debits (Automatic Clearing House) from the employee's Demand Deposit Account.

Another option is for the Employee to register their debit and/or credit cards, and have participating retailers grant/load incentive (e.g., cash-back) onto an Employee Discount Card.

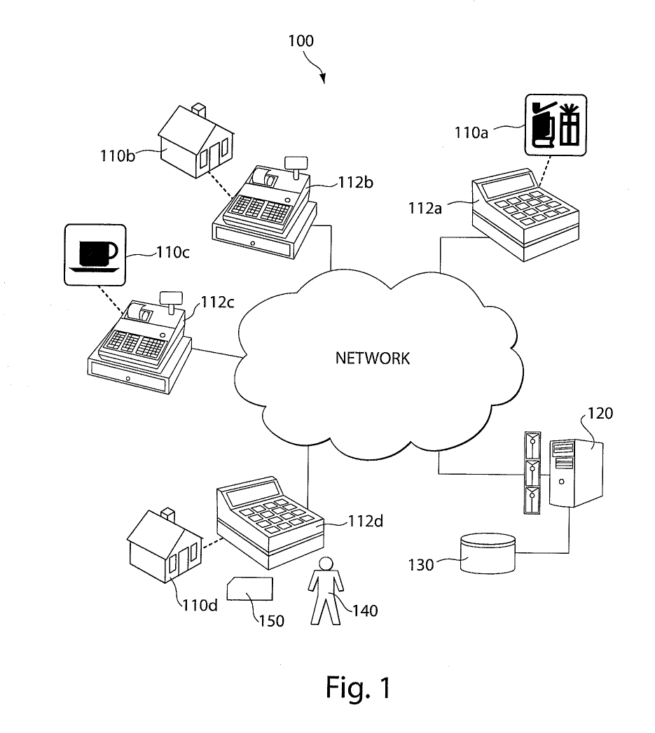

With reference to FIG. 1, a schematic diagram of a system 100 that enables the use of a card and operations therewith as described herein, and that includes multiple retailers 110a-d, is shown. Each of the retailers 110a-d includes at least one processor-based checkout device (e.g., an electronic cash register, a point-of-sale, or POS, device, etc.), namely, checkout devices 112a, 112b, 112c and 112d which are respectively associated with the retailers 110a-d. For simplicity of explanation, only four retailers and corresponding checkout devices are depicted. However, any number of retailers may be connected to the network. In some embodiments, the checkout devices may be operable by a user, such as a cardholder 140 depicted in FIG. 1, who may complete purchasing transactions without the assistance of a live operator by inputting information about an item or service the user wishes to purchase through a suitable input-interface such as, for example, an optical scanner, a magnetic card reader, a keyboard, a radio frequency identification (RFID) sensing device, etc. Having obtained the information about the purchase (e.g., the item to be purchased, the price, etc.), the purchaser proceeds to pay for the purchase (a marketable item such as a good or service) by presenting a card 150 configured to maintain data identifying the user and/or at least one organization (e.g., the user's employer, the card issuer, etc.) with which the user (cardholder) is associated. As will be described in greater details below, the card is configured to enable access to a plurality of accounts of stored values (each such account is also referred to as a “purse”) representative of monetary amounts available for making purchases. Data relating to these accounts may be recorded directly on the card, or may be stored on a remote computer-based server, such as the server 120 depicted in FIG. 1, and be accessed by using, for example, the checkout device to communicate with that remote server. In some embodiments, the card may be one or more of, for example, a pre-paid card, a debit card, and/or a credit card. In some embodiments, the card may be one or more of a magnetic strip card, a card including a RFID tag, a card configured to enable optical scanning, etc.

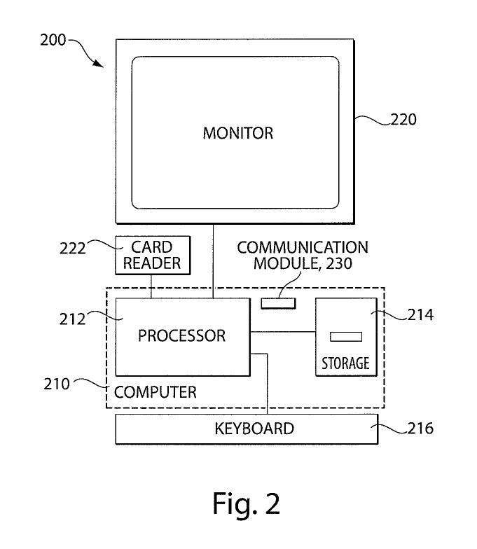

Referring to FIG. 2 a schematic diagram of an example computing system 200 that could be used for implementing any of the systems and/or devices (e.g., the checkout devices) described herein is shown. The computing system 200 includes a processor-based device 210 such as a personal computer, a specialized computing device or a reading machine and so forth, that typically includes a central processor unit 212. In addition to the CPU 212, the system includes main memory, cache memory and bus interface circuits (not shown). The processor-based device 210 includes a mass storage element 214, here typically the hard drive associated with personal computer systems. The computing system 200 may further include a keyboard 216, a monitor 220, e.g., a CRT (cathode ray tube), an LCD (liquid crystal display) monitor, plasma type display devices and/or other types of display devices. The computing system 200 may further include (e.g., in implementation of checkout devices) other input devices, including a card reader 222 such as an optical or magnetic reader (scanner) to access and read data (e.g., a user's identity, an organization identity, values representative of monetary funds, etc.) stored on a card, such as the card 150, configured to enable accessing and processing accounts (purses) to pay for purchase transactions and/or receive cash-back amounts, and also configured to enable determining other incentives (e.g., discounts).

The processor-based device 210 is configured to facilitate, for example, the implementation of card processing operations, operations to determine cash-back amounts, performance of payment operations, computations of discounts and other incentives, and other operations as described herein. The storage device 214 may thus include a computer program product comprising computer instructions that when executed on the processor-based device 210 performs operations to facilitate the implementation of the card processing operations, the operations to determine cash-back amounts, the performance of payment operations, the computations of discounts and other incentives, and the other operations described herein.

The processor-based device may further include peripheral devices to enable input/output functionality. Such peripheral devices include, for example, a CD-ROM drive, floppy drive and/or a flash drive, or a network connection, for downloading related content to the connected system. Such peripheral devices may also be used for downloading software containing computer instructions to enable general operation of the respective system/device. Alternatively and/or additionally, in some embodiments, special purpose logic circuitry, e.g., an FPGA (field programmable gate array) or an ASIC (application-specific integrated circuit) may be used in the implementation of the system 200.

Other modules that may be included with the processor-based device 210 are speakers, a sound card, a pointing device, e.g., a mouse or a trackball, by which the user can provide input to the computing system 200. The processor-based device 210 may include an operating system, e.g., Windows XP® Microsoft Corporation operating system. Alternatively, other operating systems could be used.

In some implementations, the display 210 may further include devices whose display surface is configured to receive input from a user (such as a customer or a salesperson) interacting with, for example, a checkout device. Thus, in some embodiments, the monitor 220 may include a touch screen device having a touch sensitive surface to enable users to enter data and/or make selections by directly touching areas of the screen as directed by graphical and/or audible prompts appearing on the screen.

As will be described in greater details below, information obtained by one or more of the checkout devices (e.g., by a card reader reading the card 150) may be sent to a remote central computing server system 120 (shown in FIG. 1) for recordation and processing. Thus, each checkout device may include a communication module 230, such as, for example, a transceiver, a network gateway, a wireless transceiver, etc., to transmit information collected or received at the checkout device to a remote device, such as another checkout device or a central server. Alternatively and/or additional, the collected data may be locally recorded and/or processed to generate resultant data at a processor-based device constituting part of the checkout device collecting the user's input. Information collected at a checkout device may be first stored in local storage (e.g., volatile and/or non-volatile memory) of the checkout device.

Input data obtained by a checkout device and communicated to, for example, a remote server is used, for example, to access remotely stored information about accounts available to the user to fund the purchase(s) that is to be made at a current retailer. Information recorded on the card, e.g., a user ID number, an organization identification number, etc., may be used to access the user's information, including cash accounts (purses) that are each associated with one or more retailers (or any other entity with which the user can transact).

In some implementations, the accounts associated with a user are arranged as a record that can be recorded and maintained directly on a card, or be recorded and maintained on a remote computer-based server along with records of other cardholders. Under these circumstances, the multiple records maintained for multiple cardholders may be managed through, for example, a processing/management application, e.g., a database management application such as DB2, or other conventional database management application and/or using custom-made applications developed specifically to facilitate managing and processing of account records as described herein.

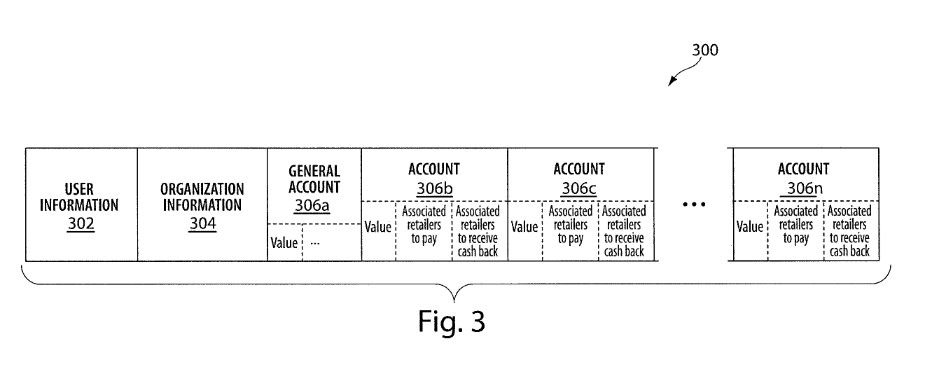

With reference now to FIG. 3, a schematic diagram of an example record 300, associated with a particular user (cardholder), and which that includes one or more accounts to pay for purchases and/or receive cash-back values, is shown. The record 300 may, in some embodiments, include, for example, a user information field 302 to store information associated with the user, including a unique user ID associated with the individual and/or the card 150, user name, user address, etc. Each of those information items may be arranged in separate sub-fields in the user information field 302, or may be stored in regular fields constituting the record 300. In some embodiments, the record 300 may be accessed, if stored at a remote server, by matching cardholder information, e.g., the user unique ID, to a user ID maintained in the record 300 (e.g., in the field 302).

The record 300 may further include an organization information field 304 that may include an organization ID to uniquely identify the organization(s), the organization(s) name(s), and other particulars of the organization(s). Here too, the organization's particulars may be arranged in separate sub-fields and/or may be assigned to different fields in the record 300. As described herein, based on the identity of the cardholder and/or the identity of the organization associated with cardholder individual, a current retailer at which the cardholder is attempting to complete a transaction (e.g., a purchasing transaction) and/or the at least one organization (including, in some embodiments, the card issuer) may determine, among other things, whether the individual is entitled to any type of cash-back, or some other incentives (e.g., discounts available only to cardholders associated with a particular organization). For example, the retailer or the card issuer may check, based on the organization ID, if the organization is one for which cardholders associated with it, receive a particular cash-back. The retailer may perform that determination by comparing the organization ID and/or the user ID against a list stored at a local retailer computing device (for example, at a checkout device at which the transaction is taking place), the card issuer at the remote server where card holders' account information (including the record 300) are stored, or at some other remote server.

As further shown in FIG. 3, the record 300 also includes one or more accounts 306a-n, or purses, to store values representative of monetary amounts available to fund or pay for purchases. At least some of the accounts may be associated with one or more specific retailers. In some embodiments, amounts in those accounts can be used to pay for purchasers only at retailers associated with those accounts for the purpose of applying values in the accounts to fund purchases at those retailers. For example, account 306b may be associated only with retailer 110b and 110c depicted in FIG. 1. Thus, when making a purchase at retailer 110b, the cardholder associated with the record 300 may apply at least some of the value stored at field 306b of the record 300 towards the purchase price. In some implementations, a retailer, the card issuer (e.g., a credit card company) and/or another organization associated with the user, may add cash-back to the card account associated with it, and the cash accrued on that account may be used to pay for purchases at that retailer as well as at one or more other retailers participating in a selective Discount Network. On the other hand, the cash in such an account may generally not be used to pay for purchases at competitors of the retailer that added cash-back to the account. Thus, for example, when the retailer 110b adds cash-back (directly or through the card issuer) to account 306c, account 306c can be used to pay for purchases at retailer 110b and at other specified retailers associated with the account. Additionally, in circumstances where the retailer at which the purchasing transaction is taking place and/or the card issuer (or some other associated organization) provides a cash-back incentive at the conclusion of the transaction, the cash-back amount determined by the retailer is then added to an account associated with the current retailer for the purpose of receiving cash-back. In some embodiments, the same account may be associated with a particular retailer to both pay for purchases at that particular retailer and receive determined cash-back amount from that particular retailer. In some embodiments, a retailer may be associated with several accounts.

Thus, in some implementations, each account field in the record 300 may be divided into multiple sub-fields that include, for example, a sub-field holding the value representative of the available monetary amount to pay for purchases, an associated retailers sub-field specifying the retailers with respect to which the value in the account may be used to pay for purchases, an associated retailers sub-field specifying the retailers with respect to which cash-back value may be added to the account, etc. As noted, in some embodiments, the retailers with respect to which cash-back value may be added to the account will be the same retailers with respect to which value from the account may be applied to pay for purchases. Another subfield that may be included with each account field is, for example, a pay cap specifying a maximum amount that can be used from the account against any purchase at the retailers associated with that account for the purpose of paying for purchases at those retailers. Other information germane to the management/processing of a particular account from the multiple accounts of the record 300 may be used.

In some implementation, at least one of the accounts of the record 300 may be a general account, for example, the account 306a, that includes a stored value that can be used to pay for transactions at any retailer (e.g., any of a pre-determined list of retailers who participate in the incentive determination procedures describe herein, such as the cash-back and/or discounts programs, and/or other retailers not participating in the incentive determination procedures described herein). Accordingly, in some embodiments, a value stored in an account determined to be associated with the current retailer can then be used to pay for a purchase to be made by the cardholder user. Any shortfall still owed after applying funds from the account(s) of the cardholder associated with the current retailer (for the purpose of paying for purchases) can then be paid from a general account associated with the card holder. Additionally, in some embodiments, if the values in the general account and in the retailer-specific accounts are not sufficient to cover the purchase price, the user may pay for the purchase price by using another card, paying cash, or in any other way to cover any shortfall in the purchase price that cannot be covered by any of the accounts associated with the card available to pay the purchase price. Generally, to complete a transaction, all the money available at a retailer-specific account associated with the current retailer for the purpose of applying funds from that account will first be used, with the balance of the purchase price not paid for through the retailer-specific account being paid for from the general account or by other methods (e.g., paying cash, using another debit/credit card, etc.)

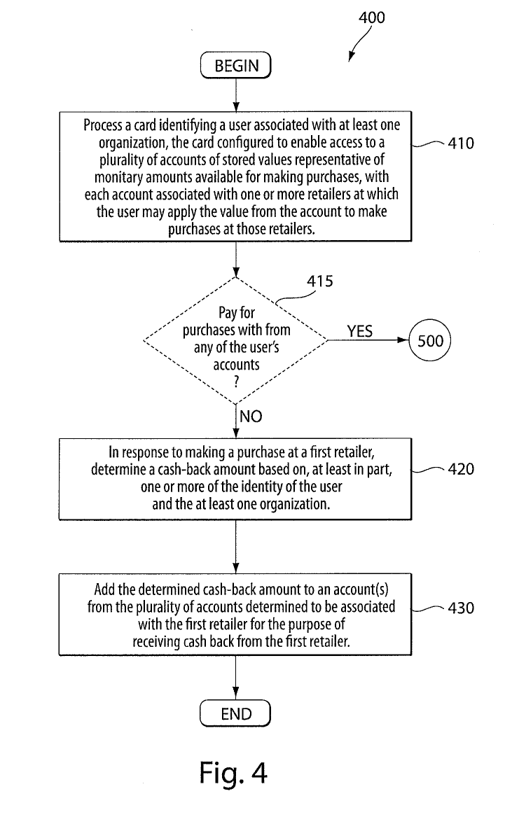

Thus, as noted, the card holder's card 150 is associated with a record that is stored on the card and/or on a remote computer-based server, and which includes one or more accounts (purses) configured to receive added cash-back values when completing a transaction (e.g., a purchase transaction) at the current retailer, as well as to pay for at least part of a transaction's price. With reference to FIG. 4, a flowchart of an example procedure 400 to provide a cash-back value, or some other incentive (e.g., redeemable points) to the card holder using a card (such as the card 150) is shown. When a cardholder is ready to complete the transaction at the current retailer (e.g., a transaction to purchase a good or service), the user presents a card, such as the card 150, to be processed via a processor-based checkout device (such as any of the checkout devices 112a-d depicted in FIG. 1). The checkout device may be operated by a live operator, or it may be configured to be operated on by the cardholder him/herself. To process the card, a card reader, e.g., a magnetic, optical, radio frequency reader, and/or any other type of card reader to scan or read the particular card, that is coupled to the checkout device, enables processing 410 of the card. As described herein, the card is configured to maintain data identifying the user and/or an associated at least one organization. For example, the associated at least one organization may include the user's employer, bank, or any other type of organization that may be enrolled in the incentive programs described herein. As further described herein, the card is configured to enable access to a plurality of accounts of stored values representative of monetary amounts available for making purchases, with each such account being associated with one or more retailers at which the user may apply the value of the each account to make a purchase at respective one or more associated retailers. Thus, when processed by the checkout device at which the card is read, the checkout device accesses, for example, data identifying the user and/or the at least one organization associated with the cardholder. In some embodiments, data about the various accounts and the stored values in them may also be retrieved directly from the card in circumstances where the card is, for example, a smartcard with non-volatile memory units included in the card to enable storage of accounts information directly on the card.

In response to the cardholder making a purchase at the current retailer, a cash-back amount is determined 420 based on, at least in part, one or more of the identity of the user identified by the card and/or the at least one organization. In some embodiments, if the identified at least one organization is amongst organizations for which the current retailer, the card issuer and/or another organization, determines and provides a cash-back, the decision as to whether and to what extent cash-back is to be provided may depend on the specific identity of the cardholder. For example, in some embodiments, only a particular class of cardholders may be entitled to a cash-back (or some other incentive) even if they are associated with the identified at least one organization (e.g., only non-manager employees of a particular employer identified by the card may be entitled to receive cash-back at the current retailer). Accordingly, the cardholder's identity (as indicated, for example, by a unique cardholder ID) and the identity of the at least one organization may be used to determine from a predetermined list (e.g., maintained on a locally stored database, or on a remote database, for example, a database maintained at the remote server where accounts information is managed) if the cardholder is even entitled to a cash-back or some other incentive.

Additionally, in some embodiments, the determination of the actual value (if any) of the cash-back may be also based, in addition to the cardholder's identity and/or the at least one organization, on the particular marketable item (e.g., goods or services) or amount being purchased, as well as, optionally, various other factors such as, but not limited to, time, date, location, etc. Such determinations may be made based on pre-developed formulas, table-based computations, etc.

Having determined the cash-back value to provide the cardholder for purchasing the marketable item, the determined cash-back amount is added 430 to an account from the plurality of accounts of the cardholder determined to be associated with the current retailer for the purpose of receiving cash-back value from the current retailer. Particularly, as noted, in some embodiments, only some (or just one) of the accounts that are associated with the cardholder may be associated with the current retailer such that computed cash-back value may be added to those accounts (an account associated with the current retailer to enable adding cash value to the account may or may not also be associated with that retailer for the purpose of applying any of the stored value in that account). The determined cash-back value is thus added to the current value stored in the account, and the sum of the added cash-back amount and the previous value stored in that account becomes available to pay for, at least partly, a subsequent purchase at retailers associated with the account (which may also include the current retailer) for the purpose of paying for purchases.

In embodiments in which the accounts information is recorded directly on the card, card processing apparatus coupled to the checkout device (e.g., a computing device electrically coupled to the card and configured to perform read/write operations on the non-volatile memory unit of the card) is used to update the values stored in the account(s) into which the cash-back value is to be added. If the current retailer is associated with more than one account of the plurality of accounts of the card for the purposes of adding cash-back value, the determined cash-back value may be apportioned between those accounts based on some predetermined formulation (e.g., equally apportioning the determined cash-back amount between the accounts associated with the current retailer for adding cash-back value), and/or based on other factors (e.g., input from the cardholder or the card issuer indicating the manner by which the determined cash-back value is to be added to the various accounts).

In embodiments in which cardholders' accounts information is stored remotely from the card, a communication module coupled to the card and/or the checkout device may establish a communication link with the remote server on which the accounts information is stored, and transmit to the server the data relevant to effect the cash-back transactions (e.g., the determined cash-back amount, the cardholder's unique ID, etc.) When the transmitted information is received at the remote server, the server, e.g., via hardware or software application to manage cardholders' accounts, performs the updating of the appropriate account(s) to add the determined cash-back value to the appropriate account(s).

In some embodiments, a user may be able to receive cash-back (and/or other incentives) by using his regular debit or credit cards. Specifically, in some embodiments, a user may register one or more of his/her regular debit or credit cards, e.g., through a web-based interface, to enable remote servers that manages transactions and accounts associated with the such cards (e.g., a bank's or credit card company's servers to manage credit/debit cards) to add cash-back to a special prepaid card or purse that may be provided to the user. Such special prepaid cards, or purses, may be restricted to a particular retailer discount network or to specific retailers (e.g., a single retailer). Such special prepaid cards and purses may include data representative of the user's identity and/or an at least one organization associated with the user. Thus, when the user uses the registered debit or credit card in the selective retailer Discount Network, cash-back may be loaded to that special prepaid card or purse (by the current retailer, by the card issuer and/or by some other organization associated with the user or card). Such a pre-paid card or purse may subsequently be used to pay for purchases, e.g., using procedures that may be similar to procedures described herein.

It is to be noted that in some implementations, the computation of a cash-back value may be preceded by applying cash from one or more of the accounts determined to be associated with the current retailers for the purpose of applying cash from those accounts to pay for the purchase. The use of some of the cash in one or more of the accounts to pay for the current purchase may also affect the actual determined cash-back value to provide the cardholder. For example, if cash from one of the retailer-specific accounts (or even the general account) accessed by the card is used to pay for the purchase, the cardholder may then only be entitled to a reduced level of cash-back, or, in some embodiments, to no cash-back at all.

Thus, optionally, prior to determining a cash-back amount to be added to one or more of the cardholder's accounts, a determination may be made 415 whether any cash available with any account associated with the cardholder's card may be used for the purpose of applying some or all of the value in any such account towards paying the purchase price. In some embodiments, this determination may be based, at least in part on indication by the cardholder or the card issuer that it wishes to apply funds in its accounts (be it a retailer-specific account or the general account) towards payment of the purchase price. The determination that values in one or more accounts associated with the cardholder's card are to be used for paying, at least partly, for the purchase, causes commencement of a procedure 500 to use the card's accounts to pay for the purchase.

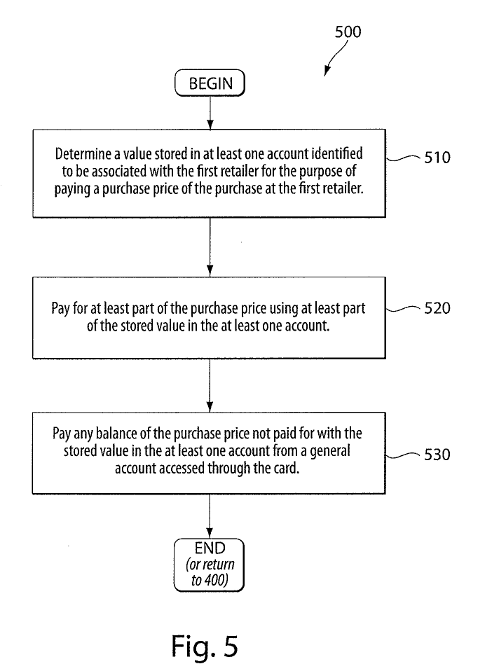

With reference to FIG. 5, a flowchart of the procedure 500 to pay the purchase price using the card of the cardholder is shown. Procedure 500 may be performed in conjunction with the procedure 400 described herein (shown in FIG. 4), or independently of the procedure 400. Thus, upon determination of the price for the marketable item(s) (goods or services) the cardholder wishes to purchase (such determination may be performed based on card processing to determine, example, any applicable discounts), the value in at least one account identified to be associated with the current retailer is determined 510. As noted, in some embodiments, the accounts identified to be associated with current retailer are those accounts that may be used to apply value stored therein to fund purchases at the current retailer. As noted, in some embodiments, accounts hold cash-back value added as a result of previous purchases at the current retailer and may thus be used to pay for purchases at that retailer or at retailers participating in a selective discount network and/or at retailers corresponding to particular Merchant Category Codes (MCC) specified by the card issuer, the retailer, and/or another organization associated with the cardholder.

In some embodiments, accounts used for the purpose of applying funds when purchasing at the current retailer may not necessarily be congruent with accounts that are associated with the current retailer for the purposes of adding cash-back value to the accounts. For example, the current retailer or the card issuer may provide cash value to be added to a particular account, but may only permit using value stored in a different account, configured to receive cash-back value from a different retailer, to pay for purchases at the current retailer.

On the other hand, in some embodiments, at least one account associated with a retailer for the purpose of paying for purchase may also be used to receive cash-back amount when transacting (e.g., purchasing) at that retailer. To determine the at least one account that is associated with the current retailer for the purposes of paying for the purchase, data in each such account (e.g., stored in one a sub-field in the account) representative of the identity of a retailer with respect to which value in the account may be used to pay for purchases at that retailer is checked to determine if the data matches the identity of the current retailer. Similarly, the value stored in the at least one account identified to be associated with the current retailer (for the purposes of paying for purchases) is retrieved. In circumstances where card account information is stored in a remote server, the checkout device transmits a request to the remote server to access the accounts associated with the cardholder, and to determine the accounts and/or stored values in those accounts using, for example, a unique identification such as the Merchant ID (MID) associated with the current retailer.

Having determined cash value (if any) in accounts associated with the current retailer for the purposes paying for of purchases, at least part of the purchase price of the purchase at the current retailer is paid for 520 using at least part of the stored value(s) in accounts identified to be associated with the current retailer for the purpose of paying for purchases at the current retailer. In some embodiments, all funds available in the retailer-specific account are first applied to the purchase price, and if there is any outstanding balance remaining, the balance may be paid for using a general account associated with the card, or be paid for in other ways. On the other hand, in some embodiments, the cardholder may indicate, e.g., through the user interface of the checkout device, that only a portion of the purchase price may be applied from one or more of the accounts identified to be associated with the current retailer for the purposes of paying for the purchase. Additionally, if there are more than one such retailer-specific account identified as being associated with the current retailer for the purposes of paying for purchases at that retailer, the cardholder and/or the card issuer may identify which of those accounts are to be used and/or how to apportion the purchase price between those identified accounts.

Once at least part of the purchase price is paid for with funds applied from the one or more accounts associated with the current retailer for the purpose of paying for purchases at the current retailer, any balance still remaining after applying the values in the retailer-specific accounts may be paid for 530 from the general account that is available to pay for any retailer (including, in some embodiments, retailers that do not otherwise accept the card to pay for purchases from, and/or do not provide cash-back to, retailer-specific accounts). In some embodiments, if the value in the general account is not sufficient to cover the remaining balance, or if the cardholder does not wish to use any or all the value stored in the general account, the cardholder may provide any outstanding amount in other ways (e.g., pay in cash, use a regular credit card or debit card, etc.)

The value(s) of the retailer-specific account(s) and/or the general account to be used to pay for the purchase is updated to decrease the value by an amount used to pay the at least part of the purchase price using that retailer-specific accounts identified and/or indicated by the cardholder to be used to pay for the purchase. In some embodiments, to cause the payment of at least part of the purchase price using the at least one account identified to be associated with the current retailer for the purpose of paying the current retailer, approval from a remote server (same or different than the remote server where the accounts information associated with the card is maintained) is required before one or more of at least one identified account can be charged for at least part of the purchase price.

As noted, in some embodiments, a cardholder may be entitled, based on the identity of the cardholder and/or the organization with which the cardholder is associated, to other types of incentives, such as, for example, discounts. Thus, at the time that a cardholder is about to complete a transaction (e.g., a purchase transaction at a current retailer), a discount specific to the cardholder may be determined based on the information associated with the card (e.g., the cardholder's ID and/or the organization ID). Such a discount may not be available to other cardholders (depending on their unique ID's and which organization such cardholders are associated with), but instead, such cardholders may be entitled to a different discount or some other incentive (for the same marketable item the first cardholder is purchasing), or may not be entitled to any type of discount for the particular marketable item being purchased. In some embodiments, specific credit/debit/prepaid cards may be entitled to receive automatic discounts on certain goods or services at the point of sales.

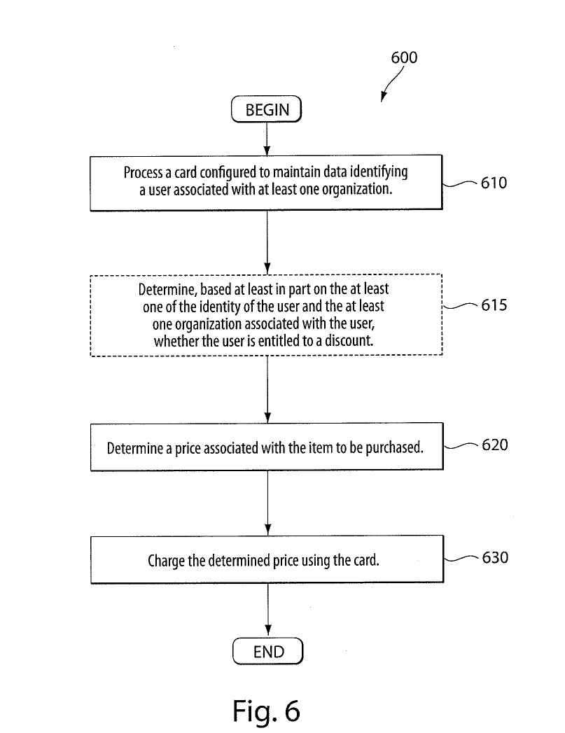

Referring to FIG. 6, a flowchart of a procedure 600 to implement discounted transaction is shown. The procedure is generally performed by execution of computer readable program code by one or more processor-based devices of a computer system (such as the computer system depicted in FIG. 2). As shown, the procedure 600 includes processing 610 (e.g., electronically reading) a card configured to maintain data identifying a user associated with at least one organization (e.g., the user's employer). Here too, the card may be configured to enable access to a stored value representative of a monetary amount available for making purchases at one or more retailers. In some embodiments, the value representative of the monetary amount available for making purchases is stored directly on the card (e.g., pre-paid card). In some embodiments, the value is stored in a remote computer server (e.g., credit card of debit card) which may be similar to, for example, the remote server 120 depicted in FIG. 1. The amount available may be determined and stored by the at least one organization (e.g., employer) as a deduction from the user's pay check.

The user may attend at any number of retailers to use the card to make regular purchases. When the user wishes to buy a product or service, the user may present the card to the retailer's representative (e.g., cashier), whereupon a determination of the price associated with a marketable item to be purchased is made 620 based on at least one of the identity of the user identified by the card and/or the at least one organization associated with the user.

Optionally, in some embodiments, determination of the price to be paid by the user is performed by first determining 615, based, at least in part, on the at least one of the identity of the user and/or at least one organization associated with the card, whether the user is entitled to a discount on the marketable item. If the user is entitled to such a discount, the price for marketable item is determined using the discount the user is entitled to. Otherwise, if the retailer does not give the holder of the card a card-specific discount, the user can still pay for the product (or service) using the card but will not receive a card-specific discount accorded to holders of such cards.

Having determined the price, the price so determined is charged 630 using the card. In some embodiments, the price is deducted directly from the value stored on the card (e.g., where the card is a pre-paid card). In some embodiments, the charge is made to an account belonging to a user (e.g., a bank account, or a credit card account) maintained at some remote computer server.

The subject matter described herein can be implemented as one or more computer program products, i.e., one or more computer programs tangibly embodied in an information carrier, e.g., in a machine-readable storage device, for execution by, or to control the operation of, data processing apparatus, e.g., a programmable processor, a computer, or multiple computers.

A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other in a logical sense and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention. Accordingly, other embodiments are within the scope of the following claims.

What is claimed is:

1. A method performed by execution of computer readable program code by one or more processor-based devices, the method comprising:
processing, by the one or more processor-based devices, a card configured to maintain data identifying one or more of a user and at least one organization, the card configured to enable access to a plurality of accounts of stored values representative of monetary amounts available for making purchases, each account being associated with one or more retailers at which the user may apply the value of the each account to make one or more purchases at the respective one or more associated retailers; and
in response to making a purchase at a first retailer, determining, by the one or more processor-based devices, a cash-back amount based on, at least in part, one or more of the identity of the user identified by the card and the at least one organization; and
adding, by the one or more processor-based devices, the determined cash-back amount to an account from the plurality of accounts determined to be associated with the first retailer for the purpose of receiving cash-back, the sum of the value stored in the account and the added cash-back amount being available to pay for, at least partly, a subsequent purchase at any of the respective one or more retailers associated with the account.

2. The method of claim 1, wherein the respective one or more retailers associated with the account at which the user may apply value from the account to pay for purchases includes the first retailer such that the account is configured to pay for the purchases at the first retailer and to receive cash-back when purchasing at the first retailer.

3. The method of claim 1, further comprising:
determining a value stored in at least one account identified to be associated with the first retailer for the purpose of paying a purchase price of the purchase at the first retailer;
paying for at least part of the purchase price using at least part of the stored value in the at least one account; and
paying any balance of the purchase price not paid for with the stored value in the at least one account from one or more of: a general account accessed through the card storing a value representative of a monetary amount available to make purchases at any retailer, available cash, a bank check, and any other credit/debit/prepaid card through a split tender transaction.

4. The method of claim 3, further comprising:
updating the value stored in the at least one account to decrease the value by an amount used to pay the at least part of the purchase price using the at least part of the stored value in the at least one account.

5. The method of claim 3, wherein the at least one account identified to be associated with the first retailer for the purpose of paying the purchase price includes the account determined to be associated with the retailer for the purpose of receiving cash-back when purchasing at the first retailer.

6. The method of claim 1, wherein at least one retailer associated with the account to apply value in the account to pay for purchases at the at least one retailer is not associated with another of the plurality of accounts such that another stored value on the other account is not available to pay for purchases at the at least one retailer.

7. The method of claim 1, wherein the card includes a pre-paid account storing the value representative of the amount, the card being one of a pre-paid card, a credit card and a debit card.

8. The method of claim 1, wherein the card is configured as one or more of a debit card and a credit card, and wherein the card is configured to enable access to a remote server maintaining data about the plurality of accounts.

9. A computer program product residing on a computer readable medium and comprising computer instructions that when executed on one or more processor-based devices cause the one or more processor-based devices to:
process a card configured to maintain data identifying a user and/or at least one organization, the card configured to enable access to a plurality of accounts of stored values representative of monetary amounts available for making purchases, each account being associated with one or more retailers at which the user may apply the value of the each account to make one or more purchases at the respective one or more associated retailers; and
in response to making a purchase at a first retailer, determining a cash-back amount based on, at least in part, one or more of the identity of the user identified by the card and the at least one organization; and
add the determined cash-back amount to an account from the plurality of accounts determined to be associated with the first retailer for the purpose of receiving cash-back, the sum of the value stored in the account and the added cash-back amount being available to pay for, at least partly, a subsequent purchase at any of the respective one or more retailers associated with the account.

10. The computer program product of claim 9, wherein the respective one or more retailers associated with the account at which the user may apply value from the account to pay for purchases includes the first retailer such that the account is configured to pay for the purchases at the first retailer and to receive cash-back when purchasing at the first retailer.

11. The computer program product of claim 9, wherein the computer instructions further comprise instructions to cause the one or more processor-based devices to:
determine a value stored in at least one account identified to be associated with the first retailer for the purpose of paying a purchase price of the purchase at the first retailer;
pay for at least part of the purchase price using at least part of the stored value in the at least one account; and
pay any balance of the purchase price not paid for with the stored value in the at least one account from a general account accessed through the card, the general account storing a value representative of a monetary amount available to make purchases at any retailer.

12. A system comprising:
one or more processor-based devices; and
a storage device coupled to the one or more processor-based devices, the storage device storing computer instructions that when executed on the one or more processor-based devices cause the one or more processor-based devices to:
process a card configured to maintain data identifying a user associated with at least one organization, the card configured to enable access to a plurality of accounts of stored values representative of monetary amounts available for making purchases, each account being associated with one or more retailers at which the user may apply the value of the each account to make one or more purchases at the respective one or more associated retailers; and
in response to making a purchase at a first retailer, determine a cash-back amount based on, at least in part, one or more the identity of the user identified by the card and the at least one organization; and
add the determined cash-back amount to an account from the plurality of accounts determined to be associated with the first retailer for the purpose of receiving cash-back, the sum of the value stored in the account and the added cash-back amount being available to pay for, at least partly, a subsequent purchase at any of the respective one or more retailers associated with the account.

13. The system of claim 12, wherein the respective one or more retailers associated with the account at which the user may apply value from the account to pay for purchases includes the first retailer such that the account is configured to pay for the purchases at the first retailer and to receive cash-back when purchasing at the first retailer.

14. The system of claim 12, wherein the computer instructions further comprise instructions to cause the one or more processor-based device to:
determine a value stored in at least one account identified to be associated with the first retailer for the purpose of paying a purchase price of the purchase at the first retailer;
pay for at least part of the purchase price using at least part of the stored value in the at least one account; and
pay any balance of the purchase price not paid for with the stored value in the at least one account from a general account accessed through the card, the general account storing a value representative of a monetary amount available to make purchases at any retailer and/or from available cash and any other debit/credit/prepaid cards through a split tender transaction.

15. A system comprising:
one or more processor-based devices; and
a storage device coupled to the one or more processor-based devices, the storage device storing computer instructions that when executed on the one or more processor-based devices cause the one or more processor-based devices to:
access, based on information obtained from a card including user identification information and information about at least one organization associated with the user, a plurality of accounts associated with a user of stored values representative of monetary amounts available for making purchases, each account being associated with one or more retailers at which the user may apply the value of the each account to make one or more purchases at the respective one or more associated retailers; and
receive information about a cash-back amount, determined, in response to making a purchase at a first retailer using the card, based on, at least in part, one or more of the identity of the user identified by the card and the at least one organization; and
add the determined cash-back amount to an account from the plurality of accounts determined to be associated with the first retailer for the purpose of receiving cash-back, the sum of the value stored in the account and the added cash-back amount being available to pay for, at least partly, a subsequent purchase at any of the respective one or more retailers associated with the account.

16. The system of claim 15, wherein the respective one or more retailers associated with the account at which the user may apply value from the account to pay for purchases includes the first retailer such that the account is configured to pay for the purchases at the first retailer and to receive cash-back when purchasing at the first retailer.

17. A device comprising:
a card having a data-recording storage medium to record data, the data to be recorded including data identifying one or more of a user and at least one organization, the card providing access to a plurality of accounts of stored values representative of monetary amounts available for making purchases, each account being associated with one or more retailers at which the user may apply the value of the each account to make one or more purchases at the respective one or more associated retailers;
wherein the card is further configured to be processed by reading apparatus located at some of one or more retailers to provide the data identifying one or more of the user and the at least one organization, the data provided being used to:
in response to making a purchase at a first retailer, make a determination of a cash-back amount based on, at least in part, one or more of the identity of the user identified by the card and the at least one organization; and
add the determined cash-back amount to an account from the plurality of accounts determined to be associated with the first retailer for the purpose of receiving cash-back, the sum of the value stored in the account and the added cash-back amount being available to pay for, at least partly, a subsequent purchase at any of the respective one or more retailers associated with the account.

18. The device of claim 17, wherein the respective one or more retailers associated with the account at which the user may apply value from the account to pay for purchases includes the first retailer such that the account is configured to pay for the purchases at the first retailer and to receive cash-back when purchasing at the first retailer.

19. The device of claim 17, wherein at least one of the plurality of accounts accessed by the card is further configured to receive value through payroll deductions by an employer of the user identified by the card.

20. The device of claim 17, wherein the card includes one of a credit card and debit card, the card being pre-registered with an issuer of the card, and wherein the plurality of accounts are accessed by another card, different from the card, such that cash-back amounts are added to one or more of the plurality of accounts in response to using the card to pay for one or more purchases at the first retailer, and values stored in the accounts are applied towards purchases in response to using the other card.
